(19) United States
(12) Patent Application Publication
(10) Pub. No.: US 2023/0324552 A1
(43) Pub. Date: Oct. 12, 2023

(54) LIDAR TECHNOLOGY-BASED METHOD AND DEVICE FOR ADAPTIVELY TRACKING AN OBJECT

(71) Applicant: ArianeGroup SAS, Les Mureaux (FR)

(72) Inventors: Alain QUENTEL, Paris (FR); Olivier MAURICE, Villebon-sur-Yvette (FR)

(21) Appl. No.: 18/043,639

(22) PCT Filed: Aug. 25, 2021
(86) PCT No.: PCT/FR2021/051486

§ 371 Date: Mar. 1, 2023

(30) Foreign Application Priority Data
Sep. 2, 2020 (FR) 2008892

(51) Int. Cl. G01S 17/66; G01S 7/481; G01S 17/58; G01S 17/86

(52) U.S. Cl. CPC G01S 17/66; G01S 7/4814; G01S 17/58; G01S 17/86; G01S 7/4817

(57) ABSTRACT

A method of tracking objects is based on the use of a LIDAR apparatus. This method includes in particular a step C) of tracking the object. Step C of tracking the object including in particular a sub-step of determining a tracking pattern to pass along by the probe laser beam along a perpendicular plane containing the estimated position of the object and which is perpendicular to a line passing via the estimated position of the object and the position of the LIDAR apparatus, at least one angular parameter of the tracking pattern in relation to the LIDAR apparatus being determined from the estimated position of the object, including in particular the distance between the object and the LIDAR apparatus.

### TECHNICAL FIELD

The invention concerns the field of the tracking of objects.

Thus, the invention more particularly relates to a method for tracking objects, and to a device for tracking objects.

### PRIOR ART

For some applications, such as the tracking of drones, aircraft, satellites or docking apparatus in the context of rendezvous in space, it is necessary to have object tracking that is at the same time functional over a relatively large distance range (for example for a few tens of meters to 1 kilometer in the context of drone tracking) and that is compatible with the high relative velocities that such objects may have.

Such tracking is currently carried out based on two principles:
(i) that of passive imaging, mainly carried out by optical camera or by sensors of radio waves or even of acoustic waves according to the emissivity range and the environment of the object to track.
(ii) that of active tracking, that is to say based on the use of an electromagnetic radiation source internal to the system, for example based on LIDAR or RADAR.

Tracking, whether based on passive imaging or active tracking, has the advantage of making it possible to detect objects to track when they appear in the field “of vision” of the tracking apparatus and is thus particularly appropriate for identifying and detecting an object to track.

However, this type of tracking has the drawback of being generally configured for tracking over a relatively small distance range directly linked to the focal length used, for optical cameras, and to a low angular resolution as regards RADAR. To increase this distance range, it is necessary, in the case of optical cameras or flash LiDAR systems, to use an optical zoom system or several cameras, such uses are relatively complex to implement, in particular when the object to track is moving at high velocity.

It will be noted that by “tracking distance range” here and in the rest of this document, is meant the range of distances between the object to track and the tracking apparatus, for example the camera or LIDAR apparatus, over which the tracking apparatus is configured to track the object.

As indicated above, some active tracking operations may be based on the emissivity of the objects to track. More particularly, certain objects to track have particular emissivity properties, for example in the field of radio waves (a drone communicating with the radio control unit over WIFI or aeronautical radiocommunication for aircraft). Nevertheless, these tracking methods being based on waves of which the wavelength is similar to that of RADAR radar systems, they have the same drawbacks and do not therefore make it possible to provide tracking with a sufficiently great angular resolution for some applications.

As regards imaging by scanning LIDAR, despite the greater angular resolution, the scanning time for a large field of view proves too great and does not enable tracking relevant to fast-moving objects.

Thus, among the tracking devices, none is suitable to provide tracking over a relatively large distance while being suitable for tracking relatively fast-moving objects

The active tracking taught by J. A. Beraldin and his co-authors in the scientific journal “Optical Engineering” No. 39, pages 196 to 212 in 2000, enables this problem to be solved in part. As a matter of fact, this type of active tracking, based on LIDAR technology, consists, as illustrated in in FIG. 1A, of making the LIDAR laser beam pass along an angular tracking pattern around an assumed position of the object (here a drone). By identifying the interception points of the object by the laser beam, it is possible to determine the actual position of the object and, as illustrated in FIG. 1B, to move the tracking pattern in order for it to be centered on the object. In this way, on the basis of a relatively simple pattern, such as a Lissajous curve, it is possible to have tracking of the movement of the object to track with a relatively high tracking frequency, since that frequency is only limited by the time taken for the laser beam probe to pass along the whole of the tracking pattern.

Nevertheless, such active tracking is suitable for a relatively small distance range which depends on the shape of the tracking pattern chosen.

Thus, to our knowledge, there is no tracking method in existence that allows the tracking of objects over a relatively great distance range (that is to say, for example, suitable for tracking from around ten meters to several kilometers) and that is, furthermore, equally suitable for objects having relatively high velocities (that is to say, which may for example be greater than 80 km/h, as is the case for drones) as for those having low velocities.

### Disclosure of the Invention

The invention is directed to mitigating these drawbacks and is thus directed to providing a method of tracking objects that is capable of tracking an object over a relatively great distance range.

The invention concerns to that end a method of tracking objects based on the use of a LIDAR apparatus, the LIDAR apparatus comprising:
a laser source configured to emit a probe laser beam, and
a movement system for moving the probe laser beam configured to modify the orientation of the probe laser beam,
the method comprising the following steps:
A. identifying an object to track,
B. estimating a position of the object, the position of the object comprising a distance between the object and the LIDAR apparatus,
C. tracking the object,
Step C of tracking the object comprising the sub-steps of:
C1. determining a tracking pattern to pass along by the probe laser beam, at least one angular parameter of the tracking pattern in relation to the LIDAR apparatus being determined from the estimated position of the object, including in particular the distance between the object and the LIDAR apparatus.
C2. moving the probe laser beam by a movement system so as to move the probe laser beam along the tracking pattern determined at step C1 and identifying the points of interception of the object by the probe laser beam during the movement of the probe laser beam,
C3. determining a position of the object from the points of interception of the probe laser beam by the identified object, the determined position comprising a distance between the object and the LIDAR apparatus.

Such a method makes it possible to provide active tracking of the object to track with a tracking pattern which is suitably configured to the distance and to the shape of the object, this being thanks to the dependency of at least one angular parameter of the tracking pattern on the distance between the object and the LIDAR apparatus. As the tracking pattern is thus suitably configured whatever the distance between the object and the LIDAR apparatus, it is possible to obtain tracking over a large distance range compared with the methods of the prior art. It will be furthermore noted that as the pattern may be relatively simple, according to the active tracking principle, such a method is compatible with high frequency tracking and may thus be used to track objects with a relatively high velocity of movement.

At the time of the implementation of tracking step C, steps C1 to C3 are reproduced successively and iteratively, the estimated position of the object used at step C1 being either, for the first iteration, the estimated position of the object obtained at step B, or, for an iteration n, n being an integer greater than or equal to 2, the position of the object determined at step C3 of the iteration n−1. In this way it is possible to ensure continuous tracking of the object to track.

In sub-step C3 of determining a position of the object, a direction of movement of the object is furthermore determined based on the estimated position used at sub-step C1 and on the position determined at sub-step C3, and
in which, at the time of the implementation of step C, for an iteration n, n being an integer greater than or equal to 2, in the sub-step C1 of determining the tracking pattern, at least one other parameter of the tracking pattern is furthermore determined based on the estimated direction of movement of the object determined at step C3 of iteration n−1.

At step C1, the tracking pattern is of the parametric curve type and at least one angular parameter is an angular parameter of the parametric curve.

Taking into account the direction of movement of the object to track to define the tracking pattern makes it possible to take into account the movement of the object to maximize the number of echoes on the object (i.e. the number of points of interception of the object by the probe laser beam) on movement of the laser along the tracking pattern. Thus, it is possible to obtain a better estimation of the positioning of the object.

In sub-step C3 of determining a position of the object, an estimated speed of movement of the object may furthermore be determined based on the estimated position used at sub-step C1 and on the position determined at sub-step C3, and
in which, at the time of the implementation of step C, for an iteration n, n being an integer greater than or equal to 2, in the sub-step C1 of determining the tracking pattern, the at least one other parameter of the tracking pattern is furthermore determined based on the estimated speed of movement of the object determined at step C3 of iteration n−1.

Using the speed of the object to track as a basis for defining the pattern it is possible to provide better taking into account of the movement of the object and thus further improve the number of echoes on the object when the laser moves along the tracking pattern.

At sub-step C3 of determining a position of the object an estimated acceleration of the object may furthermore be determined,
at the time of implementation of step C, for an iteration n, n being an integer greater than or equal to 2, in sub-step C1 of determining the tracking pattern, the at least one other parameter of the tracking pattern being furthermore determined from the estimated acceleration.

The at least one other parameter of the pattern may comprise a pattern type selected from a group of predefined patterns, the pattern type being selected from said group of predefined patterns each corresponding to a respective type of parametric curve, the pattern type being selected from said group of predefined patterns according to the estimated direction of movement and/or estimated speed of movement if the latter is available.

In this way, it is possible to choose a pattern that is particularly suited to the speed and/or direction of movement of the object to track. Optimized tracking is thus ensured.

At the time of one of step A of identifying the object to track and of step B of estimating the position of the object, there may furthermore be determined at least one estimated dimension of the object in a perpendicular plane containing the estimated position of the object and perpendicular to a line passing via the estimated position of the object and the position of the LIDAR apparatus, and
in which, at the sub-step C1 of determining the tracking pattern, the at least one angular parameter of the tracking pattern is furthermore determined from the estimated dimension.

In this way, the method may be suitably configured whatever the size of the object to track. Thus, it is easy to suitably configure a device according to the invention to enable tracking of objects of a few tens of centimeters such as certain drones of small size, or much more massive objects, such as airplanes.

Step B of estimating a position of the object may comprise the following sub-steps:
B1 obtaining a preliminary position of the object, the estimated preliminary position comprising a distance between the object and the LIDAR apparatus,
B2 determining an identification pattern to pass along by the probe laser beam along a perpendicular plane containing the estimated preliminary position of the object and perpendicular to a line passing via the estimated preliminary position of the object and the position of the LIDAR apparatus, at least one angular parameter of the identification pattern being determined from the estimated preliminary distance between the LIDAR apparatus and the object and the estimated preliminary position of the object,
B3. moving the probe laser beam by the movement system so as to move the probe laser beam along the identification pattern determined at step B2 and identifying the points of intersection between the object and the probe laser beam during the movement of the probe laser beam,
B4. determining an estimated position of the object from the points of interception of the probe laser beam by the identified object, the determined position comprising a distance between the object and the LIDAR apparatus, the estimated dimension of the object in the perpendicular plane also being determined from the points of interception of the probe laser beam by the identified object.

Such an identification pattern makes it possible to provide a size estimation of the object and to track it in a minimum time, since it is not necessary to carry out full imaging of the object or of the scene.
at step B2 of determining an identification pattern, the identification pattern may correspond to a parametric curve of a type other than that of the tracking pattern determined at step C1.

Step B of estimating a position of the object may comprise the following sub-steps:
B′1. moving the probe laser beam by the movement system so as to carry out scanning of a region of space in which the object to track is estimated to be and identifying the intersection points between the object and the probe laser beam during the movement of the probe laser beam,
B′2. determining an estimated position of the object from the points of interception of the probe laser beam by the identified object, the determined position comprising a distance between the object and the LIDAR apparatus, the estimated dimension of the object in the perpendicular plane also being determined from the points of interception of the laser beam by the identified object.

Such scanning makes it possible to obtain an image of the object to track and thus enables identification of the object to track.

Thus, in addition to making it possible to provide an estimated dimension of the object, it is possible to obtain information on the type of object to track and suitably configure the tracking pattern to that type.

The invention furthermore relates to the system for tracking objects with a LIDAR apparatus, the system comprising:
a laser source configured to emit a probe laser beam,
a movement system for moving the probe laser beam configured to modify the orientation of the probe laser beam, the laser source and the movement system participating in forming a LIDAR apparatus,
a control unit configured to control the movement system for moving the probe laser beam,
the control unit being furthermore configured for the implementation of at least step C) of a method of tracking according to the invention.

Such an object tracking system makes it possible to implement a method according to the invention and to obtain the advantages associated with the method according to the invention.

The system may furthermore comprise at least one imaging apparatus selected from the group comprising optical cameras and radar apparatuses, and in which the imaging apparatus is configured to implement at least step A) and to provide the control unit with the indications necessary for the control unit to be able to implement step B), the control unit being configured to implement step B) of the tracking method.

Such imaging apparatuses enable continuous detection of objects to track over a relatively large region. Thus, the advantages are combined of wide field passive tracking with low resolution and the accuracy of active tracking given by the method according to the invention.

The system may comprise a device for entering into communication with the control unit in which an observer having identified an object to track in accordance with step A) is able to provide the necessary indications for the control unit to implement step B), the control unit being configured to implement step B) of the tracking method.

In this way, on detection of an object to track by an observer, the aforementioned can easily set off a tracking method according to the invention to track the object it has detected.

### BRIEF DESCRIPTION OF THE DRAWINGS

The present invention will be better understood on reading the description of the example embodiments given purely by way of indication and which is in no way limiting, with reference to the accompanying drawings in which:

FIGS. 1A and 1B diagrammatically illustrate a first step and a second step of a method of tracking of active type according to the prior art;

FIG. 2 illustrates a flowchart presenting the main steps of a tracking method according to the invention;

FIGS. 3A to 3C respectively illustrate a tracking device according to the invention this being according to a first LIDAR measurement principle, the principle of movement of the laser beam by the movement system implemented in the context of the invention and in the context of LIDAR measurement, and a tracking device according to the invention, this being according to a second LIDAR measurement principle.

FIG. 4 illustrates a flowchart presenting the sub-steps of a step of tracking of the method according to the invention;

FIG. 5 illustrates the principle of determining an angular parameter of the tracking pattern based on the distance and a dimension of the object to track;

FIG. 6 illustrates the principle of adapting the dimensions of a tracking pattern in accordance with the method according to the invention;

FIG. 7 illustrates the estimation pattern principle used in the context of the estimating step to estimate a dimension of the object according to a first variant of the method according to the invention;

FIG. 8 illustrates a flowchart presenting the sub-steps of a step of estimating a position of the object of the method according to the first variant which is based on an estimation pattern as illustrated in FIG. 7,

FIG. 9 illustrates a LIDAR imaging sub-step implemented in the context of a step of estimating a position of the object according to a second variant of the invention;

FIG. 10 illustrates a flowchart presenting the sub-steps of an estimating step according to the second variant in which an imaging sub-steps is implemented;

FIGS. 11A to 11C illustrate an adaptation of the tracking pattern according to a second embodiment depending on the estimated speed of the object for an estimated speed of the object that is respectively substantially zero, intermediate or relatively great;

FIGS. 12A to 12C illustrate an adaptation of the tracking pattern according to a variant of the second embodiment depending on the estimated speed of the object for an estimated speed of the object that is respectively substantially zero, intermediate or relatively great;

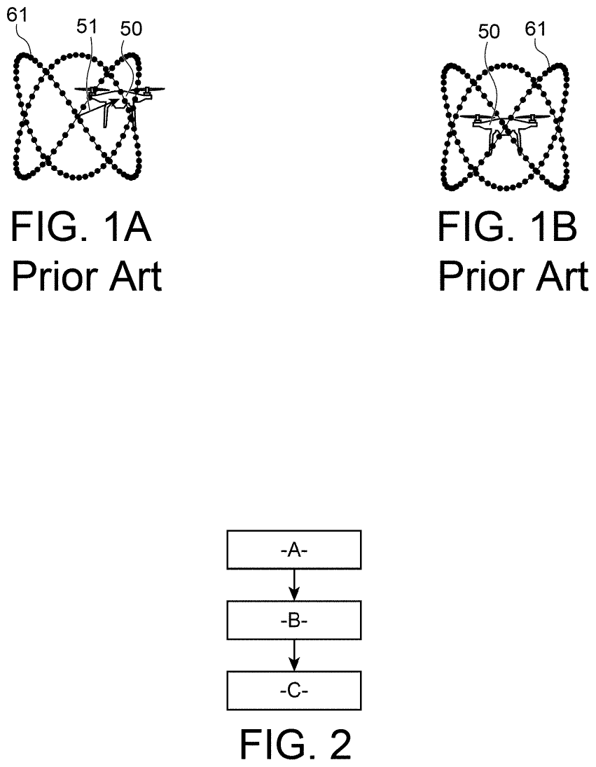

Parts that are identical, similar or equivalent of the various drawings bear the same numerical references so as to facilitate the passage from one drawing to the other.

The various parts shown in the drawings are not necessarily at a uniform scale, so as to render the drawings easier to read.

The various possibilities (variants and embodiments) must be understood as not being exclusive of each other and may be combined between each other.

### DESCRIPTION OF THE EMBODIMENTS

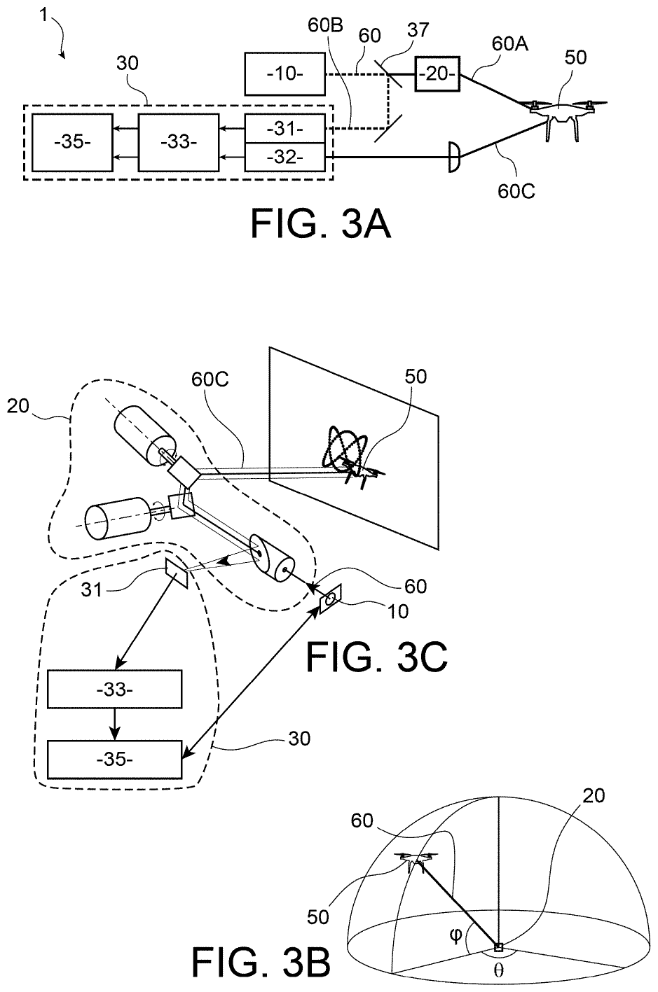

FIG. 2 is a flowchart illustrating the main steps of a method of tracking according to the invention which is based on the principle of active tracking using a LIDAR apparatus 1 such as that illustrated in FIG. 3.

It will be noted that in this present embodiment, the object to track is a drone 50. Nevertheless, although the invention may be particularly suitable for drone tracking, the invention is not limited to that application alone and concerns the tracking of any type of object that may have relative movement in relation to a LIDAR apparatus 1. Thus, although the method of the invention may concern the tracking of mobile objects such as drones, aircraft or artificial satellites from the ground, it may also be implemented in the context of tracking an object having relative movement in relation to a LIDAR apparatus, for example such as a LIDAR apparatus equipping a shuttle in the context of a rendezvous in space with a space station or an artificial satellite.

Thus, such a method of tracking is based on a LIDAR apparatus 1 which is formed by a tracking system 1 according to the invention and which is illustrated in FIG. 3. Such a LIDAR apparatus 1 comprises:
a laser source 10 configured to emit a probe laser beam 60A and
a system 20 for moving the probe laser beam 60A configured to modify the orientation of the probe laser beam 60A,
a measurement system 30 configured to detect part of the probe laser beam 60A back-scattered by the object to track 50 and to determine, based on a temporal offset between the emission of the probe laser beam 60A and the detection of the back-scattered part of the probe laser beam 60A, a distance between the object to track 50 and the LIDAR apparatus 1.

It is to be noted that by “distance between the object to track 50 and the LIDAR apparatus 1” is meant a distance between a point of the object to track, such as a point the reflective surface of the aforementioned from which the laser beam 60 is back-scattered, and a reference point of the apparatus, for example such as the movement system 20 or a virtual reference point disposed between the movement system 20 and the measurement system 30.

It is to be recalled that the measurement performed by a LIDAR apparatus 1, according to the principle shown in FIGS. 3A and 3B, is generally based on a measurement of the time between the emission of a laser pulse, included in the probe laser beam 60A, and the reception by the measurement system 30 of the part of that laser pulse back-scattered by a surface, such as the surface of the object to track 50, it being possible to directly deduce the distance between the surface and the LIDAR apparatus 1 by multiplying the time measured by the speed of light and dividing by two. Thus, based on the orientation of the probe laser beam by the movement system and that distance, it is possible to determine a position of the surface at the origin of the back-scattering of the probe laser beam.

To enable such time measurement, several LIDAR measurement principles may be implemented. Thus, according to a first measurement principle illustrated in FIG. 3A, in addition to the fact that the laser source 10 is a pulsed laser source able to emit a pulsed laser beam 60, the LIDAR apparatus further comprises a beam separator 37 in order to separate the pulsed laser beam 60 emitted by the laser source 10 into a probe laser beam 60A and a reference laser beam 60B.

The measuring system 30 comprises:
the beam separator 37,
a first radiation detection device 31, such as a photodetector (for example a photomultiplier), configured to detect the reference laser beam 60B after its separation from the probe laser beam 60A and to provide a temporal reference for emission of the probe laser beam 60A,
a second radiation detection device 32 such as a photodetector (for example a photomultiplier), configured to detect the back-scattered part 60C of the probe laser beam 60A and to provide a temporal measurement of reception of said part 60C of the probe laser beam 60A,
a computing unit 33 configured to compute, based on the temporal reference provided by the first radiation detection device 31 and the temporal measurement of reception supplied by the second radiation detection device 31, a distance between the surface of the LIDAR apparatus, and to determine from the orientation given by the movement system 20 to the probe laser beam 60A a position of that surface,
a control unit 35 configured to control the movement system 20 and the computing unit in order to implement the method according to the invention.

FIG. 3B illustrates the principle of angular movement of the laser beam by the movement system 20. It can be seen that according to this principle and based on a set of mirrors (illustrated in particular in FIG. 3C), the movement system 20 makes it possible to move the laser beam 50 angularly about two different axes of a horizontal coordinate system, an azimuth axis corresponding to a coordinate 0 in the horizontal plane (θ being comprised between 0° and, at maximum, 360°), and a vertical axis corresponding to a coordinate ϕ(ϕ being comprised between 0° and 90°). In this way, the laser beam 60 may be moved to track the object whatever its path.

According to a second LIDAR measurement principle, in accordance with FIG. 3C, it is possible that the measurement system 30 comprises only one radiation detection device 31 to detect the back-scattered part 60C of the probe laser beam 60, and not have a beam separator 37, the whole of the laser beam 60 serving as probe laser beam. According to this possibility the laser beam 60 passes through a holed parabolic mirror to be transmitted to the movement system 20 in order for the latter to move the laser beam along the tracking pattern 61 towards the object 50. When the laser beam 60 encounters a surface, such as the surface of the object 50, part 60C of the aforementioned is back-scattered towards the movement system. This part 60C of the back-scattered laser beam 60 is next, as illustrated in FIG. 3C, received by the movement system 20 and divided by the parabolic mirror towards the radiation detection device 31.

In this way, the first detector 31 is configured to detect the back-scattered part 60C of the probe laser beam 60A and to provide a temporal measurement of reception of said part 60C of the probe laser beam 60A.

It will be thus noted that according to this second measurement principle, by contrast to the measurement system 30 according to the first measurement principle, the temporal reference may be determined from the control signal transmitted to the laser source 10. Thus, the computing unit 33 is configured to compute, from the control signal transmitted by the control unit 35 and from the temporal measurement of reception supplied by the first radiation detection device 31, a distance between the surface and the LIDAR apparatus, and to determine from the orientation given by the movement system 20 to the probe laser beam 60A, a position of said surface. The configuration of the control unit 35 according to this second measuring principle stays similar to that according to the first measuring principle.

Of course, these two examples of configuration of the measurement system 30 are provided only by way of example and are in no way limiting. As a matter of fact, the person skilled in the art is entirely capable of adapting the present teaching to the different principle of distance detection that may be implemented in the context of LIDAR measurements. Thus, it may perfectly well be envisioned that the invention be adapted for LIDAR measurement systems implementing measurement systems of electronic synchronous detection type that are homodyne, or heterodyne, or on LIDAR measurement systems implementing measurement of Doppler effect optical heterodyne detection type.

Whatever the measurement system 30 employed, the method according to the invention, as illustrated in FIG. 2, comprises the following steps,
A. identifying the object 50 to track,
B. estimating a position of the object 50, the position of the object 50 comprising a distance between the object 50 and the LIDAR apparatus 1,
C. tracking the object 50.

At step A, the identification of the object may be made by:
(i) either a device external to the LIDAR apparatus, such as an optical camera, a radar, a radio wave detector, a sound sensor, or even observation by an operator,
(ii) or using the LIDAR apparatus 1 in itself.

According to possibility (i), the tracking system may furthermore comprise the external device, not illustrated. This external device is configured to monitor a space in which the object 50 may appear. When the external device detects the object, an approximate position of the object may be sent to the control unit 35 in order for that latter to be able to implement step B on the basis of the approximate position. According to this possibility, it may also be envisioned for the control unit to comprise an input device enabling an operator having identified the object 50 to provide the necessary indications for the control unit 35 to be able to implement step B.

As regards possibility (ii), the LIDAR apparatus 1 may have an imaging configuration in which the LIDAR apparatus 1 is configured to scan a space in which the object 50 may appear. If in this scanning operation an anomaly is detected which may correspond to an object 50 to track, the control unit 35 may be configured to implement step B in order to confirm the presence of the object 50 and estimate the position of the object 50.

At step B, the control unit 35 is configured to make it possible to estimate a position of the object 50 according to the LIDAR measurement principle. Such an estimation may be made by orienting, by the movement system, the probe laser beam towards an approximate position of the object obtained at step A and to measure, based on the detection of the back-scattered part of the probe laser beam, a distance between the object 50 and the LIDAR apparatus 1. Thus, such a step makes it possible to provide an estimated position of the object comprising a distance between the object 50 and the LIDAR apparatus 1.

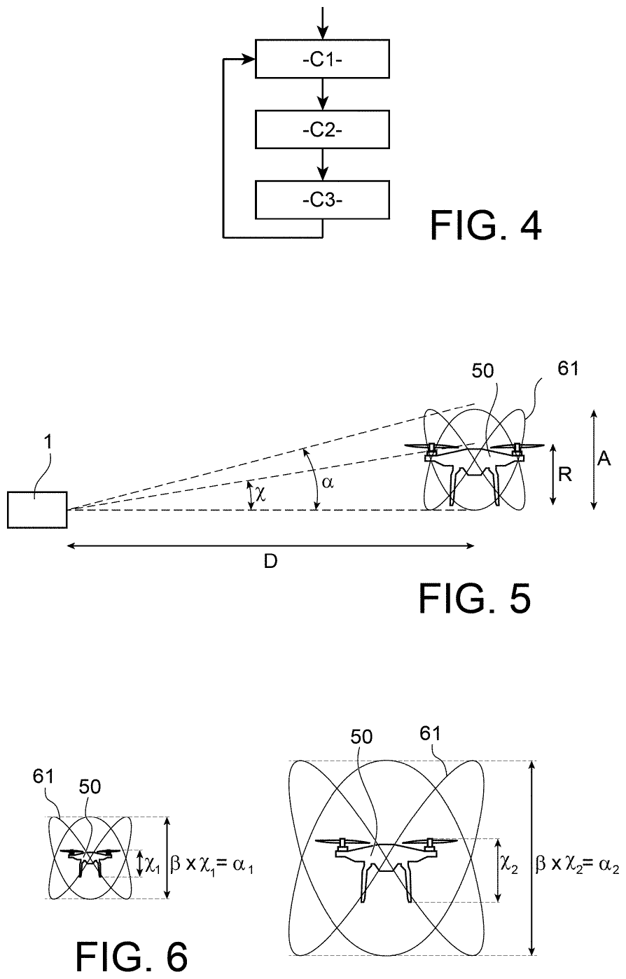

Step C of tracking the object 50 comprises, as illustrated in FIG. 4, the sub-steps of:
C1. determining a tracking pattern 61 to pass along by the probe laser beam 60A at least one angular parameter of the tracking pattern 61 in relation to the LIDAR apparatus being determined from the estimated position of the object 50, including in particular the distance between the object 50 and the LIDAR apparatus 1,
C2. moving the probe laser beam 60A by a movement system 20 so as to move the probe laser beam along the tracking pattern 61 determined at step C1, and identifying the points of interception of the object 50 by the probe laser beam 60A during the movement of the probe laser beam 60A,
C3. determining a position of the object 50 from the points of interception of the probe laser beam 60A by the identified object 50, the determined position comprising a distance between the object 50 and the LIDAR apparatus 1.

In the context of this first embodiment, the tracking pattern 61 chosen is, as illustrated in FIG. 5, a Lissajous curve with parameters p=2 and q=3 around the estimated position of the object 50.

It is to be recalled that the Lissajous curve is defined by the following parametric equation:

$$\{ \begin{matrix}x ( t ) = \frac{A}{2} sin ( p 2 πft ) + {x}_{0} \\ y ( t ) = \frac{A}{2} sin ( q 2 π ft ) + {y}_{0}\end{matrix} \qquad ( 1 )$$

With x(t) and y(t) being the coordinates of the pattern in the perpendicular plane, A being an amplitude parameter of the Lissajous curve, and p and q corresponding to the “pulses” of the sinusoidal movements with q>p (here p=2 and q=3), f being a reference frequency, x₀ and y₀ corresponding to the offset of the tracking pattern 61 to make the tracking pattern match the estimated position of the object 50.

Of course, the Lissajous curve illustrated in FIG. 5 is only an example of a tracking pattern compatible with the invention and other patterns may perfectly well be envisioned without departing from the scope of the invention, it being possible, for example, for the tracking pattern to be a spiral or a circle. It will be noted that, whatever the case, the tracking pattern is preferably chosen for its capacity to optimize the number of echoes on the object 50 (the number of points of interception of the object by the probe laser beam) and the capacity to “trap” the object by reducing the possibility of escape.

Thus, at the step C1, the angular parameters of the tracking pattern 61 are defined, as illustrated in FIG. 5, based on the estimated position of the object to track including in particular the distance D between the object 50 and the LIDAR apparatus.

As a matter of fact, according to the principle of the invention in which the size of the tracking pattern is configured to an estimated or expected dimension R, of the object, the amplitude parameter A will be proportional to that estimated or expected dimension R, this proportionality, which may be materialized by a factor β, tubing chosen according to a maximum expected speed of movement and/or to maximize the number of echoes on the object 50. Thus, this parameter A may be equal to B.R with β being the proportionality factor and R being the dimension of the object 50 which is either estimated or expected. As a matter of fact, it will be noted that, when the type of object to track is known in advance (in this present embodiment, drones), it is possible to define an expected dimension of said object, for example 50 cm or 1 m according to the type of drone. According to a first possibility of the invention and in the case of a pattern that is a Lissajous curve, the parameter A may be fixed and predetermined. As a variant, as will be described in connection with FIGS. 6 to 8, it may be calculated from an estimated dimension R of the object 50 determined at a step A and step B.

As already described in connection with FIG. 3B, the movement system 20 being able to modify the orientation of the probe laser beam 60A, or in other words perform angular movement thereof, passing along the tracking pattern 61 by the probe laser beam 60A along the perpendicular plane corresponds to a change of angular coordinate of the probe laser beam 60A according to a reference frame following a horizontal coordinate system the origin of which is the LIDAR apparatus 1.

Thus, if we take the parametric equation described above, this becomes, with such a change in angular coordinate:

$$\{ \begin{matrix}θ ( t ) = arctan ( \frac{\frac{β . R}{2} sin ( p 2 πft )}{D} ) + {θ}_{O} ∼ \frac{β . R}{2 D} sin ( p 2 π ft ) + {θ}_{O} \\ φ ( t ) = arctan ( \frac{\frac{β . R}{2} sin ( q 2 πft )}{D} ) + {φ}_{O} ∼ \frac{β . R}{2 D} sin ( q 2 πft + ϕ ) + {φ}_{O}\end{matrix} \qquad ( 2 )$$

With θ(t) and ϕ(t) being the angular coordinates of the probe laser beam 60A of the tracking pattern according to a reference frame centered on the LIDAR apparatus 1 with θ(t) corresponding to one of the azimuth axes and ϕ(t) corresponding to the vertical axis, θ₀ and ϕ₀ corresponding to the angular offset of the tracking pattern 61 to make the tracking pattern match the estimated position of the object 50.

In other words, taking into account that the ratio R/2D is expected to be relatively low, the distance D being generally greater than 10 m or even than 50 m for an expected dimension between 50 cm and 1 m, the angular amplitude θ of the object equal to arctan(R/D) may be approximated by R/D and thus the angular amplitude of the pattern, as shown by the above equation and FIG. 5, may be approximated by α=R/D.

Thus, the above parametric equation may be re-written as follows:

$$\{ \begin{matrix}θ ( t ) ∼ \frac{β . χ}{2} sin ( p 2 πft ) + {θ}_{O} = \frac{α}{2} sin ( p 2 πft ) + {θ}_{O} \\ φ ( t ) ∼ \frac{β . χ}{2} sin ( q 2 πft ) + {φ}_{O} = \frac{α}{2} sin ( q 2 πft + ϕ ) + {φ}_{O}\end{matrix} \qquad ( 3 )$$

FIG. 6 illustrates this dependency for the angular amplitude of the pattern as a function of the distance D between the object and the LIDAR apparatus 1, this being for two objects 50, a first, on the left side, being relatively remote and having an angular amplitude x₁ and a second, on the right side, being relatively near to the LIDAR apparatus and having an angular amplitude X₂. As these two illustrates show, and taking into account the angular amplitude x₁, X₂ of the object 50, in particular obtained from the distance D between the object 50 and the LIDAR apparatus, to calculate the angular amplitude α₁, α₂, it is possible to provide a tracking pattern 61 perfectly configured for the dimensions and the location of the object 50. With such an adaptation, the risk of escape of the object 50 is significantly reduced.

Of course, such an example of parametrizing the tracking pattern is only provided by way of example and is in no way limiting. Thus, if the angular amplitude α of the tracking pattern 61 may have a direct relationship of proportionality with the angular amplitude θ of the object 50, it may be envisioned that this relation be different without departing from the scope of the invention. Thus for example, it may be envisioned that the angular amplitude a of the tracking pattern 61 varies also with the square of the angular amplitude θ in order to provide a tracking pattern 61 of greater angular amplitude α when the object 50 is relatively close to the LIDAR apparatus 1.

In the context of the invention, in order to provide continuous tracking of the object 50, upon implementation of tracking step C, steps C1 to C3 may be reproduced successively and iteratively, the estimated position of the object used at step C1 being either, for the first iteration, the estimated position of the object 50 obtained at step B, or for an iteration n, n being an integer greater than or equal to 2, the position of the object determined at step C3 of the iteration n−1.

In this way, in addition to the continuous tracking of the object 50, this tracking is carried out with a tracking pattern of which the angular parameter, i.e. in the present embodiment, the angular amplitude a, is determined on the basis of an updated estimated position of the object 50, this being in particular in respect of the distance D between the object 50 and the LIDAR apparatus 1.

In order to provide a tracking pattern 61 particularly suited to the object 50, according to certain variants of the invention, at one of the step A of identifying the object to track and step B of estimating the position of the object, there is furthermore determined an estimated dimension R of the object 50 in the perpendicular plane.

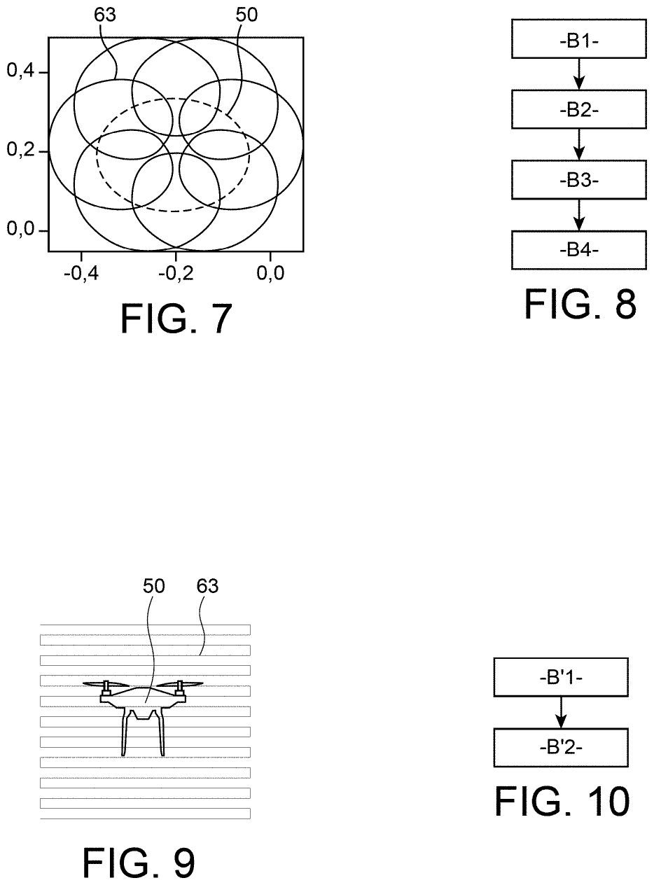

According to the first variant, the estimation of the dimension R of the object 50 may be made by means of a movement of the laser beam according to an identification pattern 63 in accordance with what is illustrated in FIG. 7. Thus, if this determination of the at least one estimated dimension of the object 50 is carried out at step B, the step B may comprise, in accordance with the flowchart of FIG. 8, the following sub-steps:
B1 obtaining a preliminary position of the object 50, the estimated preliminary position comprising a distance between the object 50 and the LIDAR apparatus 1,
B2 determining an identification pattern 63 to pass along by the probe laser beam 60 along a perpendicular plane containing the estimated preliminary position of the object 50, and perpendicular to a line passing via the estimated preliminary position of the object 50 and the position of the LIDAR apparatus 1, at least one angular parameter of the identification pattern 63 being determined from the estimated preliminary distance between the object 50 and the LIDAR apparatus 1 and the estimated preliminary position of the object,
B3. moving the probe laser beam by the movement system so as to move the probe laser beam along the identification pattern 63 determined at step B2 and identifying the points of intersection between the object and the probe laser beam during the movement of the probe laser beam,
B4. determining an estimated position of the object 50 from the points of interception of the probe laser beam 60A by the identified object 50, the determined position comprising a distance between the object 50 and the LIDAR apparatus 1, the estimated dimension of the object in the perpendicular plane also being determined from the points of interception of the probe laser beam 60A by the identified object 50.

Thus, in the context of sub-step B1, the control unit 35 is configured to obtain a preliminary position of the object 50. To do this, the control unit 35 may be configured to communicate with the external device used in the context of step A or to use information provided by the operator having identified the target in the context of step A in order to determine an estimated position of the object 50. It will be noted that in this context, the control unit 35 may also determine, from that communication or from that gathering of information, the type of the object.

Once this information on the preliminary position of the object has been obtained, the control unit 35 is configured in order to determine, in the context of sub-step B2, an identification pattern 63 to pass along by the probe laser beam 60A in the perpendicular plane to determine a dimension of the object 50 in the perpendicular plane. Such an identification pattern 63 may, for example and as illustrated in FIG. 7, be a rose the angular amplitude of which is greater than a maximum angular amplitude expected for the object 50.

Of course, such a form of rose is only given by way of example and is in no way limiting, the invention covering any other type of identification pattern 63, such as a star-shaped or spiral pattern. Similarly and as a variant, the identification pattern 63 may also be, without departing from the scope of the invention, identical to the tracking pattern and thus be, in the present embodiment, a Lissajous curve.

If the example of the rose, or epitrochoid, is taken, illustrated in FIG. 7, according to a similar principle to that described in the context of the tracking pattern 61 of Lissajous curve form, the identification pattern 63 may be in accordance with the following parametric equation:

$$\{ \begin{matrix}θ ( t ) = arctan ( \frac{{β}^{′} . R max}{2 D} ( 14 cos ( 2 πft ) - 12 cos ( 14 πft ) ) ) + {θ}_{O}^{′} \\ φ ( t ) = arctan ( \frac{β′ . R max}{2 D} ( 14 sin ( 2 πft ) - 12 sin ( 14 πft ) ) ) + {φ}_{O}^{′}\end{matrix} \qquad ( 4 )$$

With β′ being a proportionality factor, Rmax being a maximum expected dimension of the object 50 in the perpendicular plane, θ′₀ and ϕ₀ corresponding to the angular offset of the tracking pattern 61 to make the tracking pattern match the preliminary position of the object 50.

Taking into account the distance D, as for the tracking pattern, the parametric equation may be approximated as follows:

$$\{ \begin{matrix}θ ( t ) ∼ \frac{{β}^{′} . R max}{2 D} ( 14 cos ( 2 πft ) - 12 cos ( 14 πft ) ) + {θ}_{O}^{′} \\ φ ( t ) ∼ ( \frac{β′ . R max}{2 D} ( 14 sin ( 2 πft ) - 12 sin ( 14 πft ) + {φ}_{O}^{′}\end{matrix} \qquad ( 5 )$$

Thus, according to this example embodiment of this first variant embodiment, the angular amplitude A′ of the identification pattern 63 is a function of the proportionality factor β′, of the maximum expected dimension Rmax and of the preliminary distance D included in the preliminary position of the object 50.

According to a second variant of the first embodiment, the estimated dimension of object 50 may be obtained by a step of imaging around a preliminary position of the object 50 this being over a region of space of a size greater than a maximum expected dimension Rmax of the object 50, as is illustrated in FIG. 9. This estimated dimension may be obtained either at step A of identifying the object 50, or at step B of estimating a position of the object 50.

According to this second variant of the invention, and considering that the estimated dimension is obtained on implementation of step B of estimating a position of the object 50, estimating step B may comprise, as is illustrated in FIG. 10, the following sub-steps:
B′1. moving the laser beam by the movement system 20 so as to carry out scanning of a region of space in which the object to track is estimated to be and identifying the intersection points between the object 50 and the probe laser beam 60A during the movement of the laser beam,
B′2. determining an estimated position of the object 50 from the points of interception of the laser beam by the identified object 50, the determined position comprising a distance D between the object 50 and the LIDAR apparatus 1, the estimated dimension of the object 50 in the perpendicular plane also being determined from the points of interception of the probe laser beam 60A by the identified object 50.

According to a third variant of the invention, at step A or step B, a sub-step of identifying the type of the object 50 may be provided. Thus, in accordance with this possibility, one or more parameters may be changed according to the type of object 50 identified. Thus, for example, in the context of this first embodiment, the drone to track may be identified as being:
(1) either a micro-drone,
(2) or a drone flying at medium altitude, or
(3) a drone of flying-wing type.

The tracking pattern 61 may then be chosen, at step C1 of determining the tracking pattern 61 according to the dimensional characteristics and movement expected for the identified drone type.

Of course, although in these first, second and third variants of the invention, the estimated dimension may be obtained in the context of estimation step B, the person skilled in the art is capable of modifying the methods according to these variants in order for it to be obtained in the context of step A of identifying an object to track, without departing from the scope of the invention.

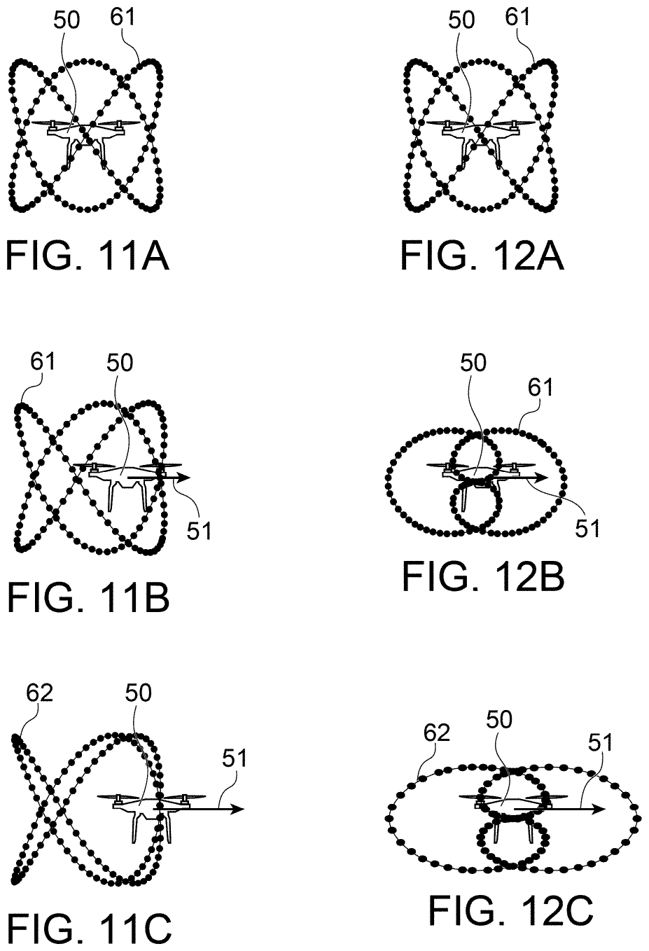

FIGS. 11A to 11C illustrate the adaptability of the tracking pattern 61 according to the movement of object 50 implemented in a method according to a second embodiment.

A tracking method according to this second embodiment is distinguished from a tracking method according to the first embodiment in that in the sub-step C1 of determining the tracking pattern 61, this is determined based on movement information of the object 50 determined on implementing a preceding step C3.

Thus, in accordance with this second embodiment, in sub-step C3 of determining a position of the object, a direction of movement is furthermore determined, and possibly a speed of movement, which are estimated for the object 50 based on the estimated position used at sub-step C1 and on the position determined at sub-step C3, and
at the time of the implementation of step C, for an iteration n, n being an integer greater than or equal to 2, in the sub-step C1 of determining then tracking pattern, at least one other angular parameter of the tracking pattern is furthermore determined based on the estimated speed of movement of the object 50 determined at step C3 of iteration n−1.

Thus, in accordance with this second embodiment and when the tracking pattern 61 is a Lissajous curve in accordance with the first embodiment, and if a movement of the object 50 is considered along the x-axis, it is possible to apply a phase shift ϕ between the x-axis and y-axis of the Lissajous curve as a function of the speed of movement. Such a phase shift ϕ may thus be an angular correction of the tracking pattern 61 in accordance with the following parametric equation:

$$\{ \begin{matrix}θ ( t ) ∼ \frac{β . χ}{2} sin ( p 2 π ft ) + {θ}_{O} = \frac{α}{2} sin ( p 2 π ft ) + {θ}_{O} \\ φ ( t ) ∼ \frac{β . χ}{2} sin ( q 2 π ft + ϕ ) + {φ}_{O} = \frac{α}{2} sin ( q 2 π ft + γ \frac{V}{Vm} ) + {φ}_{O}\end{matrix} \qquad ( 6 )$$

With γ being a second proportionality factor, V being the estimated speed of movement of the object 50 and Vm being a maximum expected speed for the object.

It will also be noted that it is also possible to correct the phase shift ϕ between the x-axis and y-axis of the Lissajous curve according to, in addition to the speed of movement, an estimated acceleration of the object. For this, in the sub-step C3 of determining a position of the object an estimated acceleration of the object 50 may furthermore be determined.

It can be seen in FIGS. 12A to 12C that such a phase shift makes it possible to obtain a density of passage of the probe laser beam that is greater at the location of the expected position of the object 50 taking into account the estimated speed. Thus, for a stationary object as shown by FIG. 11A, the tracking pattern 61 is not deformed, whereas for a relatively high speed, as shown by FIG. 11C, the tracking pattern is strongly deformed to take into account the expected position of the object.

Of course, the deformation described below is only given by way of example, the person skilled in the art being capable, based on this disclosure, of providing a different type of deformation to take into account the estimated speed V of the object 50. It will be noted, in particular, that it may perfectly well be envisioned, without departing from the scope of the invention, that the other parameter of the tracking pattern be determined solely on the basis of the estimated direction of movement or on the basis of an approximate speed and/or direction of movement.

In the same way, according to one possibility of the invention, it may perfectly well be envisioned that at the time of the first iteration at least one parameter of the tracking pattern 61 be determined from an estimated direction of movement while for the iterations n, n being an integer greater than or equal to 2, the at least one parameter of the tracking pattern 61 is determined from a direction of movement and from a speed of movement that are estimated.

According to a variant of this second embodiment illustrated by FIGS. 12A to 12C, the adaptation of the tracking pattern 61 according to the speed may be obtained by a change in the type of pattern. Thus, according to the example embodiment and as illustrated in FIG. 12A, the tracking pattern 61 is chosen for a stationary object, or one having a relatively low speed, as being a Lissajous curve similar to that described in the context of the first embodiment. For the objects 50 with greater movement, as shown in FIGS. 12B and 12C, the tracking pattern 60 is chosen as being an epitrochoid of which the axis of symmetry is made to coincide with the direction of movement of the object 50, this pattern having a high beam density on the edges while keeping points at the center.

Equation with an example of deformation according to the axis θ as a function of the speed V and the proportionality coefficient δ

$$\{ \begin{matrix}θ ( t ) = \frac{α}{2} ( δ \frac{\vert V \vert}{V m} + 1 ) ( sin ( 2 πft ) - sin ( 6 πft ) ) + {θ}_{O} \\ φ ( t ) = \frac{α}{2} ( cos ( 2 πft ) - cos ( 6 πft ) ) + {φ}_{O}\end{matrix} \qquad ( 7 )$$

It will be noted that the angular parameters of this epitrochoid curve are determined as a function of the speed V of the object this being to maximize the number of echoes.

Thus, according to this variant of the second embodiment, the at least one other parameter of the tracking pattern determined from the estimated direction of movement of the object a type of pattern selected from a predefined group of patterns, the type of pattern being selected from said group of predefined patterns according to the estimated direction of movement and/or the estimated speed of movement V if that speed is available. Here the pattern group comprises a Lissajous curve in accordance with the first embodiment and an epitrochoid curve of which the axis of symmetry is oriented as a function of the direction of movement of the object to track.

In the same way, in the context of this variant, the at least one other parameter of the tracking pattern may also be determined from an estimated acceleration of the object 50.

What is claimed is:

1. A method of tracking objects based on the use of a LIDAR apparatus, the LIDAR apparatus comprising:
a laser source configured to emit a probe laser beam and
a system for moving the probe laser beam configured to modify the orientation of the probe laser beam,
the method comprising the following steps:
A. identifying an object to track,
B. estimating a position of the object, the position of the object comprising a distance between the object and the LIDAR apparatus,
C. tracking the object,
Step C of tracking the object comprising the sub-steps of:
C1. determining a tracking pattern, of the parametric curve type, to pass along by the probe laser beam, the tracking pattern corresponding to a parametric curve with at least one angular parameter of the parametric curve of the tracking pattern relative to the LIDAR apparatus, which is determined from the estimated position of the object, including in particular the distance between the object and the LIDAR apparatus,
C2. moving the probe laser beam by a movement system, so as to move the probe laser beam along the tracking pattern determined at step C1 and identifying the points of interception of the object by the probe laser beam during the movement of the probe laser beam,
C3. determining a position of the object from the points of interception of the probe laser beam by the identified object the determined position comprising a distance between the object and the LIDAR apparatus, wherein at the time of the implementation of tracking step C, steps C1 to C3 are reproduced successively and iteratively, the estimated position of the object used at step C1 being either, for the first iteration, the estimated position of the object obtained at step B, or, for an iteration n, n being an integer greater than or equal to 2, the position of the object determined at step C3 of the iteration n−1 wherein in sub-step C3 of determining a position of the object a direction of movement of the object is furthermore determined based on the estimated position used at sub-step C1 and on the position determined at sub-step C3, and
wherein, at the time of the implementation of step C, for an iteration n, n being an integer greater than or equal to 2, in the sub-step C1 of determining the tracking pattern, at least one other parameter of the parametric curve of the tracking pattern is furthermore determined based on the estimated direction of movement of the object determined at step C3 of iteration n−1.

2. The method of tracking objects according to claim 1, wherein in sub-step C3 of determining a position of the object an estimated speed of movement of the object is furthermore determined based on the estimated position used at sub-step C1 and on the position determined at sub-step C3, and
wherein, at the time of the implementation of step C, for an iteration n, n being an integer greater than or equal to 2, in the sub-step C1 of determining the tracking pattern, the at least one other parameter of the tracking pattern is furthermore determined based on the estimated speed of movement of the object determined at step C3 of iteration n−1.

3. The method of tracking objects according to claim 2, wherein the sub-step C3 of determining a position of the object an estimated acceleration of the object is furthermore determined,
wherein, at the time of implementation of step C, for an iteration n, n being an integer greater than or equal to 2, in sub-step C1 of determining the tracking pattern, the at least one other parameter of the tracking pattern is furthermore determined from the estimated acceleration.

4. The method of tracking objects according to claim 2, wherein the at least one other parameter of the pattern comprises a pattern type selected from a group of predefined patterns each corresponding to a respective type of parametric curve, the pattern type being selected from said group of predefined patterns according to the estimated direction of movement and/or estimated speed of movement if the latter is available.

5. The method of tracking objects according to claim 1, wherein at the time of one of step A of identifying the object to track and of step B of estimating the position of the object, there is furthermore determined at least one estimated dimension of the object in a perpendicular plane containing the estimated position of the object and perpendicular to a line passing via the estimated position of the object and the position of the LIDAR apparatus, and
wherein, at the sub-step C1 of determining the tracking pattern, the at least one angular parameter of the tracking pattern is furthermore determined from the estimated dimension.

6. The method of tracking objects according to claim 5, wherein step B of estimating a position of the object comprises the following sub-steps:
B1 obtaining a preliminary position of the object, the estimated preliminary position comprising a distance between the object and the LIDAR apparatus,
B2 determining an identification pattern to pass along by the probe laser beam along a perpendicular plane containing the estimated preliminary position of the object, and perpendicular to a line passing via the estimated preliminary position of the object and the position of the LIDAR apparatus, at least one angular parameter of the identification pattern being determined from the estimated preliminary distance between the LIDAR apparatus and the object and the estimated preliminary position of the object,
B3. moving the probe laser beam by the movement system so as to move the probe laser beam along the identification pattern determined at step B2 and identifying the points of intersection between the object and the probe laser beam during the movement of the probe laser beam,
B4. determining an estimated position of the object from the points of interception of the probe laser beam by the identified object, the determined position comprising a distance between the object and the LIDAR apparatus, the estimated dimension of the object in the perpendicular plane also being determined from the points of interception of the probe laser beam by the identified object.

7. The tracking method according to claim 6, wherein at step B2 of determining an identification pattern, the identification pattern corresponds to a parametric curve of a type other than that of the tracking pattern determined at step C1.

8. The method of tracking objects according to claim 1, wherein step B of estimating a position of the object comprises the following sub-steps:
B′ 1. moving the probe laser beam by the movement system so as to carry out scanning of a region of space in which the object to track is estimated to be and identifying the intersection points between the object and the probe laser beam during the movement of the probe laser beam,
B′2. determining an estimated position of the object from the points of interception of the laser beam probe by the identified object, the determined position comprising a distance between the object and the LIDAR apparatus, the estimated dimension of the object in the perpendicular plane also being determined from the points of interception of the laser beam by the identified object.

9. A system for tracking objects from a LIDAR apparatus, the system comprising:
a laser source configured to emit a probe laser beam,
a movement system for moving the probe laser beam configured to modify the orientation of the probe laser beam, the laser source and the movement system participating in forming a LIDAR apparatus,
a control unit configured to control the movement system for moving the probe laser beam,
wherein the control unit is furthermore configured for the implementation of at least step C) of the method of tracking according to claim 1.

10. The system for tracking objects from a LIDAR apparatus according to claim 9, wherein the system furthermore comprises at least one imaging apparatus selected from the group comprising optical cameras and radar apparatuses, and wherein the imaging apparatus is configured to implement at least step A) and to provide the control unit with the indications necessary for the control unit to be able to implement step B), the control unit being configured to implement step B) of the tracking method.

11. The system for tracking objects from a LIDAR apparatus according to claim 9, wherein the system comprises a device for entering into communication with the control unit in which an observer having identified an object to track in accordance with step A) is able to provide the necessary indications for the control unit to implement step B), the control unit being configured to implement step B) of the tracking method.
